(19) United States
(12) Patent Application Publication
(10) Pub. No.: US 2023/0397636 A1
(43) Pub. Date: Dec. 14, 2023

(54) STABLE COATED CINNAMIC ALDEHYDE COMPOSITIONS FOR ANIMAL FEED AND RELATED METHODS

(71) Applicant: KEMIN INDUSTRIES, INC., Des Moines, IA (US)

(72) Inventors: Qingyun PENG, Zhuhai (CN); Zhen XUE, Zhuhai (CN); Linfeng MAI, Zhuhai (CN); Zhuo TANG, Zhuhai (CN); Shengshu HUANG, Zhuhai (CN)

(73) Assignee: KEMIN INDUSTRIES, INC., DES MOINES, IA (US)

(21) Appl. No.: 18/204,197

(22) Filed: May 31, 2023

Related U.S. Application Data
(60) Provisional application No. 63/351,663, filed on Jun. 13, 2022.

(51) Int. Cl. A23K 20/111; A23K 40/30; A23K 50/30; A23K 50/75

(52) U.S. Cl. CPC A23K 20/111; A23K 40/30; A23K 50/30; A23K 50/75

(57) ABSTRACT

The present invention relates to a coated cinnamic aldehyde that includes an acidic coating, and optionally a polymer coating, and remains stable when combined with animal feed or other raw ingredients for up to ninety days after combination with animal feed or raw feed ingredients. Another aspect of the present invention relates to a method of improving the growth of an animal by adding the coated cinnamic aldehyde composition to the animal feed.

### CROSS-REFERENCE TO RELATED APPLICATIONS

The present application claims the benefit of priority to U.S. Provisional Patent Application No. 63/351,663, filed Jun. 13, 2022, entitled “Stable Coated Cinnamic Aldehyde Compositions for Animal Feed and Related Methods,” which claims priority to International Patent Application No. PCT/CN2022/096376, filed May 31, 2022, entitled “Stable Coated Cinnamic Aldehyde Compositions for Animal Feed and Related Methods,” the entire disclosures of which are hereby incorporated by reference in their entireties.

### BACKGROUND OF THE INVENTION

Cinnamic aldehyde, or cinnamaldehyde, is an essential oil that can be found in the cinnamon leaf oil. It has been described as a yellow oily liquid, with a cinnamon odor and sweet taste. Cinnamic aldehyde is regarded as having antimicrobial properties and has been deemed an acceptable flavoring agent in animal feed. Indeed, cinnamic aldehyde is generally recognized as safe approved as a feed ingredient by FDA (21 CFR § 582.60, https://www.ecfr.gov/current/title-21/chapter-I/subchapter-E/part-582) and AAFCO (AAFCO, Section 582.60). Along with carvacrol and thymol, cinnamic aldehyde (CIN), is one of the most frequently used essential oil (EO) products used in feed.

Despite this acceptance in the animal feed industry, cinnamic aldehyde-based products, including those that are encapsulated or un-encapsulated, suffer from stability issues once combined with the animal feed. Commercial products currently available on the market have known stability challenges and drawbacks.

Those in the feed industry have sought to address the stability concerns by creating a physical barrier, such as encapsulation or microencapsulation using palm fatty acid or glyceryl monostearate, which have not been able to inhibit aldimine condensation between CIN and amine function groups in protein feedstuff. In other words, even with these physical barriers, the encapsulation is not sufficient to stabilize the CIN once it is combined with any feed or feed raw materials that contain protein feedstuff.

Therefore, the researchers set out to overcome the stability hurdles associated with CIN through the development of a new essential oil product. The researchers have unexpectedly identified a novel approach, using a chemical barrier, to achieve a stable CIN product that remains stable when combined with animal feed or other raw ingredients.

### BRIEF SUMMARY OF THE INVENTION

The present invention relates to compositions containing coated cinnamic aldehyde as an ingredient, where the final product exhibits improved stability when combined with animal feed or other raw ingredients, for instance raw ingredients with protein feedstuff. Another aspect of the present invention relates to preparing a stable CIN-product for animal feed that comprises a cinnamic aldehyde core and an acidic layer that acts as a chemical barrier when combined with animal feed. Another aspect of the present invention relates to providing an alternative to animal growth promoters that includes a stable CIN-product for animal feed, where the CIN-product comprises a cinnamic aldehyde core and an acidic layer.

### DETAILED SUMMARY OF THE FIGURES

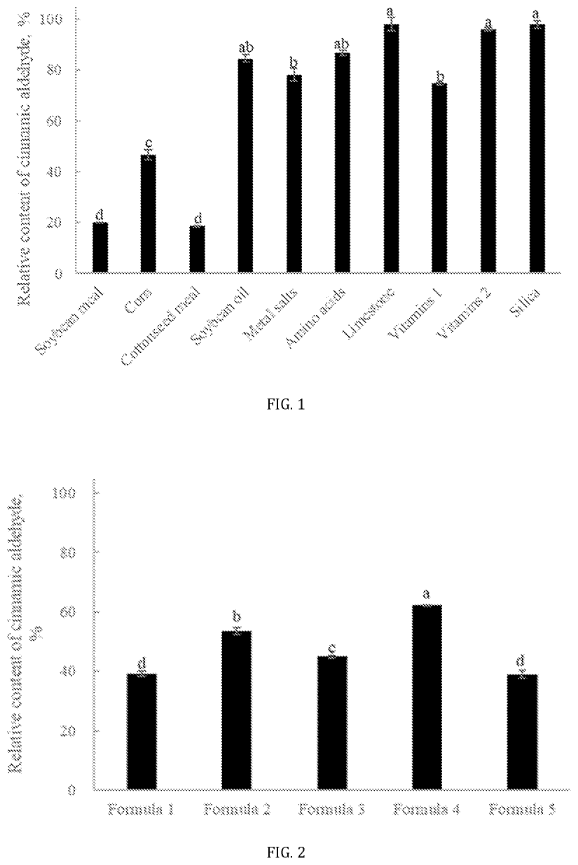

FIG. 1 is a chart reflecting the effects of feed ingredients on the stability of cinnamic aldehyde after 12 days ambient storage.

FIG. 2 is a chart showing the stability of cinnamic aldehyde in different formulas.

FIG. 3 is a chart showing the stability of cinnamic aldehyde in different formulas in feed.

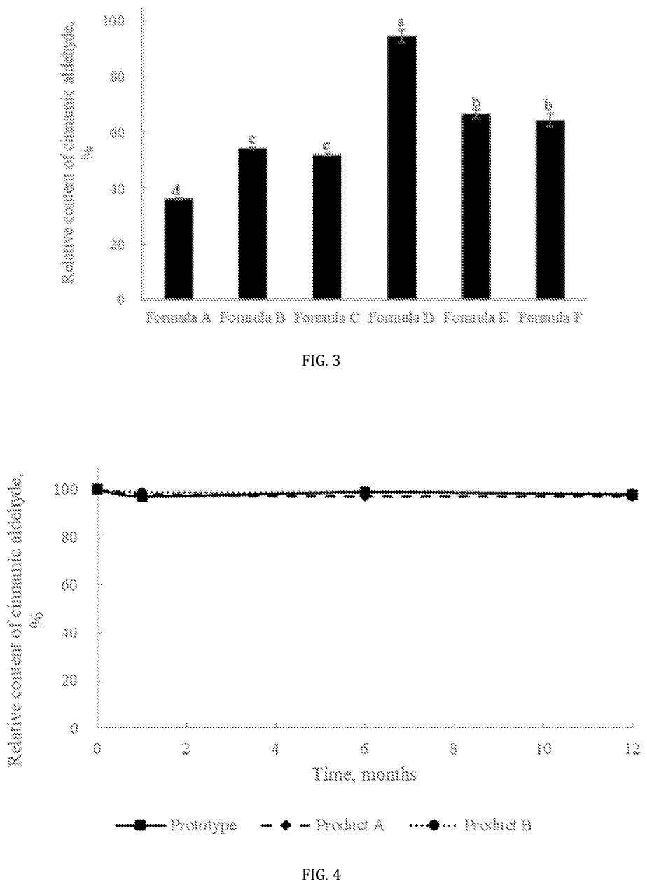

FIG. 4 is a chart showing the shelf-life stability of CIN in sample and other two commercial products.

FIG. 5 is a chart showing the stability of CIN-based products in mash feed.

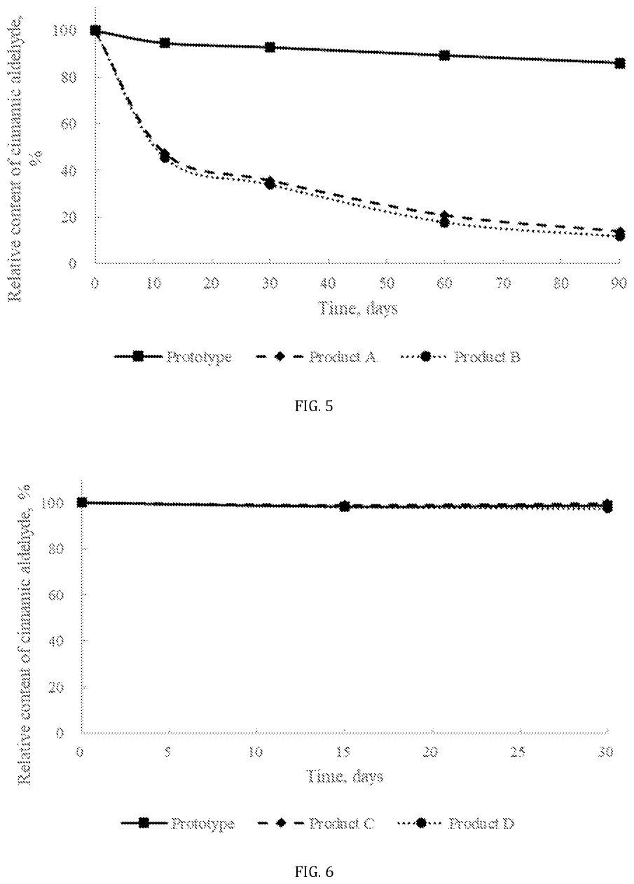

FIG. 6 is a chart showing the shelf-life stability of CIN content in sample and two commercial products

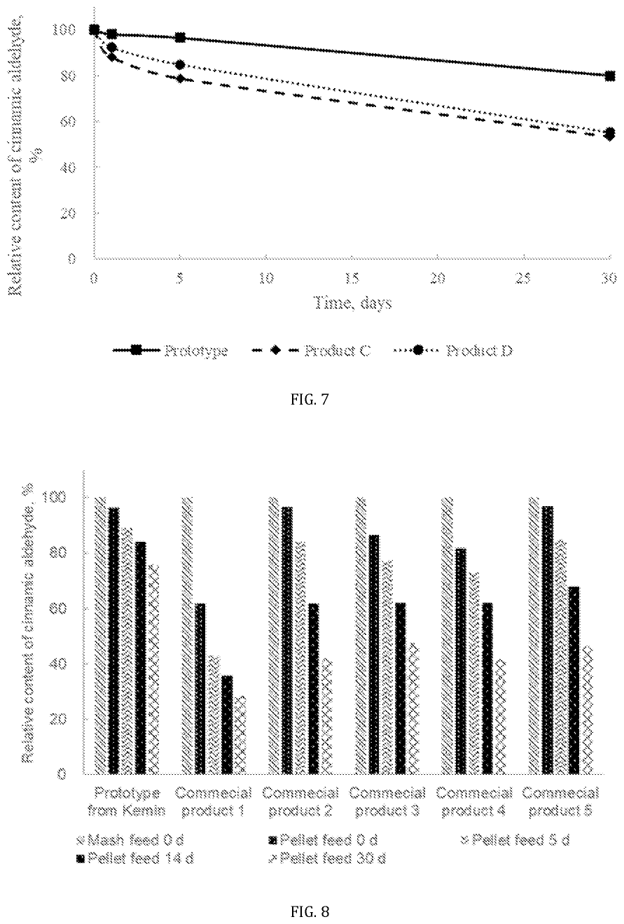

FIG. 7 is a chart showing the stability of CIN-based products in concentrated feed over time

FIG. 8 is a chart showing the stability of CIN in prototype sample and other products in pellet feed.

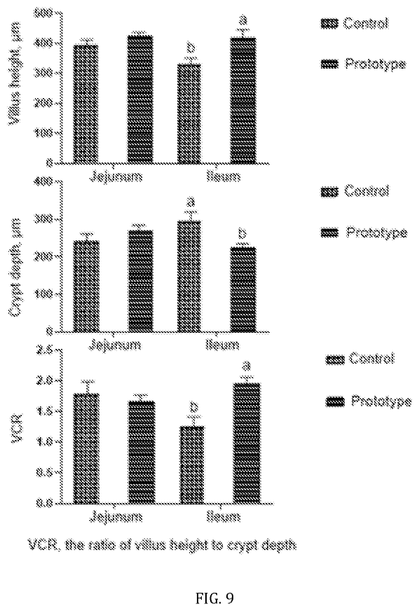

FIG. 9 is a chart showing the effects of dietary Prototype on villus height, crypt depth and the ratio of villus height to crypt depth in the jejunum and ileum of piglets at 28 days of age.

### DETAILED SUMMARY OF THE INVENTION

The present invention relates to stable compositions containing an effective amount of CIN for animal feed, where the final product overcomes the previous stability challenges associated CIN when combined with animal feed or other raw ingredients by using an acidic layer as a chemical barrier.

The researchers unexpectedly and surprisingly found that CIN degraded much faster in the protein feedstuffs than in other ingredients. The researchers considered whether aldimine condensation might be the major cause for the degradation of CIN, in view of the observation that there was a greater presence of primary amines in these protein feedstuffs. The researchers surprisingly found that a chemical barrier, for instance, blocking the degradation pathway of aldimine condensation would translate into superior stability of CIN.

In order to demonstrate its superior stability, the CIN-product of the present invention, using a chemical barrier, was compared against two leading encapsulated CIN products that utilize a physical barrier only. All three encapsulated products demonstrated very good stability during the shelf life of the CIN products. However, when the CIN products were mixed with animal feed and then stored at ambient storage for 12 days, the CIN in the two commercially available products degraded more than 50%. In other words, it became very clear that a physical barrier, for instance a product employing known encapsulation technology, without more, does not adequately address the stability hurdles of CIN once it is combined with the animal feed.

The researchers further identified that the combination of an acidic layer (chemical barrier) and a polymer layer (physical barrier) to encapsulate CIN was very effective to stabilize CIN in feed.

Accordingly, one aspect of the present invention relates to preparing a stable CIN-product for animal feed that comprises a cinnamic aldehyde core, an acidic layer that acts as a chemical barrier, and a polymer encapsulation as a physical barrier.

According to at least one embodiment, the core comprises at least 20% of cinnamic aldehyde, for instance about 35% to 55%. In addition to comprising cinnamic aldehyde, the core may optionally contain an antioxidant. In alternative embodiments, the core contains butylated hydroxytoluene (BHT), tert-butylhydroquinone (TBHQ), carvacrol, thymol, or eugenol.

According to at least one embodiment, the core beads contain CIN are coated with an organic acid, such as citric acid, tartaric acid, malic acid, fumaric acid, sorbic acid, ascorbic acid, lactic acid, oxalic acid, or mixtures thereof, to inhibit the reaction with amines, followed by a second coating with a polymer in order to block the physical contact with air and feed, using a fluid bed coating method. In alternative embodiments, the acidic coating is applied using pan coating or extrusion spheronization equipment. In alternative embodiments, the polymer coating can be accomplished using pan coating or extrusion spheronization equipment.

According to at least one embodiment of the present invention, core beads containing CIN and antioxidant were coated with a layer of organic acid to inhibit the reaction with amines, followed by a second polymer coating to block the physical contact with air and feed by fluid bed coating method. According to another embodiment, the combination of citric acid as stabilizer in the first coating film and sodium carboxymethyl cellulose (CMC-Na) in the second coating film was found to be particularly advantageous for stabilizing CIN. For instance, the coated CIN showed less than 15% loss after ambient storage with animal feed for 90 days.

In at least one embodiment, the researchers observed that the combination of citric acid as stabilizer in the first coating film and sodium carboxymethyl cellulose (CMC-Na) in the second coating film resulted in stabilized CIN. For instance, the coated CIN showed less than 15% loss after ambient storage with feed for 90 days, far less than that observed by commercially available products that include only a physical barrier.

According to at least one embodiment of the present invention, the CIN product includes a core that contains CIN, an acidic layer (chemical barrier), and a polymer layer (physical barrier) to stabilize CIN even after it has been combined with animal feed or raw ingredients.

Another aspect of the present invention relates to a CIN-product that exhibits superior stability compared to existing CIN products on the market when combined with animal feed. For instance, in at least one embodiment, the core containing CIN is then coated with an acidic layer. This can be accomplished through pan coating or spraying the core with an acid, such as an organic acid citric acid, tartaric acid, malic acid, fumaric acid, sorbic acid or mixtures thereof. The coating materials include sodium carboxymethyl cellulose (CMC-Na), polyacrylic resin II, hydroxypropyl methyl cellulose, calcium stearate, glycerol, talc powder or mixtures thereof. The pH value of the coating solution ranged from 1 to 4. In at least one embodiment, the acid accounts for about 0.5 to 15% by weight.

Another aspect of the present invention relates to providing an alternative to animal growth promoters that includes a stable CIN-product for animal feed, where the CIN-product comprises a core that contains CIN, an acidic layer that serves as a chemical barrier, and wherein the CIN-product is stable when combined with animal feed. According to at least one embodiment, the composition is added to animal feed to improve growth parameters, such as feed intake and body weight. According to at least one embodiment, the composition is a natural alternative to animal growth promoters, and the composition does not include an animal growth promoter.

According to at least one embodiment, in order to achieve a CIN-product that is stable when combined with animal feed, CIN is loaded in silica bead and encapsulated with a polymer layer to block the evaporation and prevent the contact of CIN with oxidants and primary amines.

According to at least one embodiment, the cinnamic aldehyde is present in an amount ranging from about 20 to about 50% by weight, with the silica beads content in the range of about 15 to about 40% by weight.

According to at least one embodiment, the acid can be citric acid and/or other mild-strong acid, where the acid is present in an amount ranging from about 0.5 to about 15% by weight.

According to at least one embodiment, the sodium carboxymethyl cellulose (CMC-Na) content is about 1 to 15% by weight.

In alternative embodiments, the CIN product optionally includes an antioxidant, including but not limited to BHT, TBHQ, carvacrol, thymol, or mixtures thereof. According to at least one embodiment, the antioxidant is present in an amount ranging from about 0.01 to 10% by weight. In certain embodiments, the antioxidant is included in the core. In alternative embodiments, the antioxidant is included in the acid layer.

According to at least one embodiment, the compositions of the present invention are suitable for animal feed and can be combined with known animal feed ingredients, including but not limited to soybean meal, fishmeal, corn, cottonseed meal, whey powder, formula milk powder, soybean oil, amino acid, salt, limestone, dicalcium phosphate, choline chloride, mineral premix, vitamin premix, or combinations thereof.

For purposes of this disclosure, “animal feed” refers to feed or food intended for consumption by livestock, including for instance poultry, swine, pet or ruminant animals and “protein feedstuff” refers to feedstuff containing high level of protein including plant-based proteins.

### EXAMPLES

### Example 1

Materials. Acetonitrile (HPLC, ≥99.9%) was purchased from Sigma-Aldrich LLC. Cinnamic aldehyde reference standard (Cin, 99.5%), niacin, choline chloride, dicalcium phosphate and casein were purchased from Shanghai Aladdin Biochemical Technology Co., Ltd. Ethanol were purchased from Guangzhou Chemical Reagent Factory. Syringes (5 mL) were purchased from Jiangxi Hongda medical equipment Group Ltd. Methionine, lysine and threonine, ZnSO₄, FeSO₄, MnSO₄, CuSO₄, vitamins (VA, VD₃, VE, VB₁, VB₂, VB₆, VB₁₂), D-calcium pantothenate, biotin and folic acid were purchased from Jiangsu Ease Biotechnology Co., Ltd. Salt and limestone were purchased from Guangzhou Chemical Reagent Factory.

Effects of feed ingredients on the stability of cinnamic aldehyde. The feed ingredients were assigned to different groups: soybean meal, cornmeal, cottonseed meal, soybean oil, amino acid (methionine, lysine and threonine), salt series (salt, limestone, dicalcium phosphate and choline chloride), metal sulfate (ZnSO₄, FeSO₄, MnSO₄ and CuSO₄), vitamins series 1 (VA, VD₃, VE, VB₁, VB₂, VB₆ and VB₁₂), and vitamins series 2 (D-calcium pantothenate, niacin, biotin and folic acid). Silica was used as carrier. The ingredients groups were separately added to silica according to their content in feed. Cinnamic aldehyde standard was mixed with mixture of ingredient and silica. Ten grams of samples were collected after storage at room temperature for 12 days and mixed with 50 mL ethanol in a beaker. Then sample was stirred at for 2 h with three replicates. Supernatant was filtered to vials. Then the content of CIN in feed were determined using HPLC. The relative content of cinnamic aldehyde was calculated based on initial added CIN content and the remaining content in feed ingredients by Equation 1.

$$Relative content ( \% ) = \frac{100 \times ( A - At )}{A} \qquad ( 1 )$$

where A and Aₜ are the initial content and the remaining content in feed at sampling time point (t), respectively.

CIN degraded much faster in the protein feedstuffs than in other ingredients (FIG. 1). It was suspected that aldimine condensation might be the major cause for the degradation of CIN because there were much more primary amines in these protein feedstuffs.

### Example 2

Preparation of core beads. BHT and thymol were dissolved in cinnamic aldehyde and then mixed with carvacrol. The essential oil mixture was completely absorbed by silica beads and mixed well as the core beads for coating (Table 1).

Screening of coating materials. The core beads were coated with different coating materials by fluid bed coating technology. Candidate formulas and materials of the film are given in Table 1. The coating process was performed as follows: core beads were loaded into the vessel of fluid bed and the solution of coating materials were sprayed onto the surface of core beads via a peristaltic pump. After drying at 40° C. for 10 minutes, the resulting coated granules were collected for stability analysis. The coated granules were mixed with other ingredients to create the prototype mixture. The prototype was mixed with feed at 3 kg/ton dosage. The feed was stored in sealed bags at room temperature for 12 days. Then the samples were collected from bags to determine the content of cinnamic aldehyde using HPLC. The ratio of the residual content in feed after storage for 12 days to initial content was used to reflect the stability (%). The relative content of cinnamic aldehyde was calculated according to Equation 1.

TABLE 1
Formulas for the screening of coating materials
for cinnamic aldehyde granules.

| | | Formulas (%) | | | | |
|---|---|---|---|---|---|---|
| Item | Raw materials | 1 | 2 | 3 | 4 | 5 |
| Core beads | Cinnamic aldehyde | 47.0 | 47.0 | 47.0 | 47.0 | 47.0 |
| | Carvacrol | 9.4 | 9.4 | 9.4 | 9.4 | 9.4 |
| | Thymol | 4.7 | 4.7 | 4.7 | 4.7 | 4.7 |
| | BHT | 0.8 | 0.8 | 0.8 | 0.8 | 0.8 |
| | Silica beads | 38.1 | 38.1 | 38.1 | 38.1 | 38.1 |
| Coating film | Polyacrylic resin II | | | | | 8.0 |
| | Ethyl cellulose | | 8.55 | 6.33 | | 1.0 |
| | Hydroxypropyl | | | 2.22 | | |
| | methyl cellulose | | | | | |
| | CMC-Na | | | | 3.5 | |
| | Glycerol | | | | 1.0 | |
| | Triethyl citrate | | | | | 0.8 |
| | Talc powder | | | | 1.0 | 2.4 |
| | Calcium stearate | | 1.92 | 1.92 | 1.0 | |
| | Ethanol (95%) | | 71.62 | 71.62 | | 74.1 |
| | DI Water | | 17.91 | 17.91 | 93.5 | 13.7 |

The CMC-Na based formulation (Formula 4) exhibited the best protective efficacy (P<0.05) (FIG. 2). Therefore, CMC-Na formulation was identified as a preferred coating material.

Optimization of coating formulars. The core beads coated with one layer of film could not solve the stability of CIN in feed. Different coating formulas were proposed to solve this issue (Table 2). The preparation of core beads and coating of first film and second film was conducted as described above. The stability of coated CIN granules was evaluated as described in screening of coating materials.

TABLE 2
Coating formulas for cinnamic aldehyde granules.

| | | Formulas | | | | | |
|---|---|---|---|---|---|---|---|
| Item | Raw materials | A | B | C | D | E | F |
| Core | Cinnamic | 57.69 | 57.69 | 57.69 | 57.69 | 57.69 | 57.69 |
| beads | aldehyde | | | | | | |
| | BHT | 3.85 | 3.85 | 3.85 | 3.85 | 3.85 | 3.85 |
| | Silica beads | 38.46 | 38.46 | 38.46 | 38.46 | 38.46 | 38.46 |
| First film | CMC-Na | | 1.5 | 3.5 | 1.5 | 1.5 | 1.5 |
| | Glycerol | | | 1.0 | | | |
| | Talc powder | | | 1.0 | | | |
| | Calcium stearate | | | 1.0 | | | |
| | Citric acid | | 30 | | 30 | | |
| | Sodium citrate | | | | | 30 | |
| | Glucose | | | | | | 30 |
| | DI Water | | 68.5 | 93.5 | 68.5 | 68.5 | 68.5 |
| Second | CMC-Na | | | | 3.5 | 3.5 | 3.5 |
| film | Glycerol | | | | 1.0 | 1.0 | 1.0 |
| | Talc powder | | | | 1.0 | 1.0 | 1.0 |
| | Calcium stearate | | | | 1.0 | 1.0 | 1.0 |
| | DI Water | | | | 93.5 | 93.5 | 93.5 |

The coated CIN granules produced by Formula D exhibited the highest recovery of CIN from feed after 12 days storage in feed (P<0.05) (FIG. 3). The Formula D containing citric acid as stabilizer in the first coating film and sodium carboxymethyl cellulose (CMC-Na) in the second coating film was chosen as the prototype to stabilize CIN in feed.

### Example 3

Materials. The prototype sample was prepared using coated cinnamic aldehyde (CIN) granules, which was then tested against two commercially available CIN-based (coated) products, Product A and Product B. The contents of EO components in each of the samples are summarized in Table 3.

TABLE 3
Content of components in essential oil products.

| | Content of EO components (%) | | |
|---|---|---|---|
| Sample | Cinnamic aldehyde | Carvacrol | Thymol |
| Product A | 13.62 | 3.41 | 6.00 |
| Product B | 15.41 | 2.58 | 2.58 |
| Prototype | 16.78 | 2.80 | 1.41 |

Shelf-life stability. The products were separately stored in sealed aluminum foil bags at room temperature (25° C.), respectively for 12 months. Then the samples were collected from bags at different time points to determine the content of cinnamic aldehyde using HPLC. Cinnamic aldehyde in the three products was stable under ambient storage at 25° C. for one year (FIG. 4).

Stability in mash feed. The sample and the two commercially available products (Product A and Product B) were mixed with mash feed at 3 kg/ton dosage, respectively. The feed was stored in sealed bags at room temperature for 90 days. Then the samples were collected from bags at different time points to determine the content of cinnamic aldehyde using HPLC.

The ratio of the residual content in feed after storage for different time to initial content was used to reflect the stability (%). The prototype showed good stability (>85% retention) of CIN in mash feed for 90 days (FIG. 5), while the two commercially available products did not.

### Example 4

Materials. A customized sample using coated CIN granules was prepared and tested against two coated CIN based commercial products: Product C and Product D. The contents of EO in products were showed in Table 4. The concentrated feed for piglet contained 34.26% crude protein.

TABLE 4
Content of components in essential oil products.

| | Cinnamic | | | |
|---|---|---|---|---|
| Samples | aldehyde, % | Eugenol, % | Carvacrol, % | Thymol, % |
| Prototype | 10.12 | 2.63 | 6.81 | 3.13 |
| Product C | 9.43 | 1.88 | 5.62 | 2.99 |
| Product D | 13.33 | 3.47 | 7.29 | 4.06 |

Shelf-life stability of products. The products were separately stored in sealed aluminum foil bags at room temperature (25° C.), respectively for 30 days. Then the samples were collected from bags at different time points to determine the content of cinnamic aldehyde using HPLC method. Cinnamic aldehyde in all three products was stable under ambient storage at 25° C. for 30 days (FIG. 6).

Stability in the concentrated feed. The sample and the two commercially available products, Product C and Product D, were mixed with concentrated feed at 3 kg/ton dosage respectively. The feed was stored in sealed bags at room temperature for 30 days. Then the samples were collected from bags to determine the content of cinnamic aldehyde by HPLC method. The ratio of the residual content in feed after storage for 30 days to initial content was used to reflect the stability (%). The prototype sample exhibited the best stability in concentrated feed (FIG. 7) with less than 15% loss.

### Example 5

Materials. Six mash feeds and six pellet feeds containing different essential oil products were evaluated. The first prototype sample, prepared by Kemin, contained coated CIN. The information of other 5 samples was unknown.

Stability in pellet feed. The feed was stored in sealed bags at room temperature for 30 days. Then the samples were collected from bags to determine the content of cinnamic aldehyde by HPLC method. The ratio of the residual content in pellet feed after storage for 30 days to initial content in mash feed was used to reflect the stability (%). The prototype sample overperformed all other products for its superior stability in pellet feed (FIG. 8), with substantially less CIN loss (24%) compared to loss of other samples (>50%).

### Example 6

Materials and methods, broiler study. The trial was performed according to the animal welfare regulations of China. The trial was conducted at Feed Research Institute, Chinese Academy of Agricultural Sciences, Beijing, China. A total of 288 one-day-old male Arbor Acre broilers were weighed at day 1 and randomly distributed into 3 treatments with 8 replicate pens per treatment with 12 birds per pen. The corn-soybean meal-based diets were formulated to meet or exceed the nutrient requirements as recommended by NRC (1994) and the Agricultural Trade Standardization of China (NY/T33-2004) for broilers. Prototype was obtained from Kemin (China) Technologies Co., Ltd. The dietary treatments were as follows: 1) no challenge control (NCC), 2) challenge control (CC), and 3) CC+200 mg/kg Prototype (Prototype). All birds received continuous light throughout the experiment. On day 7 and day 12, all birds except NCC group were challenged by gavage once per day with 1.0 mL of actively growing culture of E. coli 078 (2.0×10⁸ CFU/mL). Pelleted feed and water were provided ad libitum.

Growth performance. Body weight (BW) and feed intake were recorded on day 1, day 7, day 12 and day 21 and average daily gain (ADG), average daily feed intake (ADFI) and feed conversion ratio (FCR) were calculated accordingly. Prototype could improve the growth performance of broilers after challenge with E. coli (Table 5).

TABLE 5
Effects of Prototype supplementation on growth performance of broilers.

| | Experimental diets | | | |
|---|---|---|---|---|
| | | Control | Prototype | |
| Item | Control | (Challenge) | (Challenge) | P-value |

1 to 7 d

| | | | | |
|---|---|---|---|---|
| BW at 7 d | 191.4 ± 4.8 | 184.2 ± 16.4 | 192.1 ± 13.2 | 0.510 |
| ADG, g/d | 21.2 ± 0.7 | 20.2 ± 2.3 | 21.3 ± 1.9 | 0.517 |
| ADFI, g/d | 23.0 ± 0.9 | 22.0 ± 2.2 | 22.5 ± 1.7 | 0.644 |
| FCR, g/g | 1.085 ± 0.034 | 1.092 ± 0.032 | 1.060 ± 0.029 | 0.148 |

7 to 12 d

| | | | | |
|---|---|---|---|---|
| BW at 12 d | 390.7 ± 12.0 | 371.1 ± 27.0 | 389.5 ± 17.0 | 0.099 |
| ADG, g/d | 39.4 ± 2.1 | 38.4 ± 3.8 | 38.9 ± 1.4 | 0.659 |
| ADFI, g/d | 42.5 ± 4.2 | 44.3 ± 5.7 | 39.4 ± 3.6 | 0.110 |
| FCR, g/g | 1.077 ± 0.070^{ab} | 1.156 ± 0.122^{a} | 1.014 ± 0.095^{b} | 0.033 |

12 to 21 d

| | | | | |
|---|---|---|---|---|
| BW at 21 d | 952.9 ± 29.3^{a} | 895.7 ± 48.2^{b} | 956.0 ± 47.3^{a} | 0.049 |
| ADG, g/d | 61.0 ± 3.5^{a} | 52.9 ± 6.7^{b} | 57.5 ± 4.4^{ab} | 0.032 |
| ADFI, g/d | 81.1 ± 3.7 | 78.4 ± 6.5 | 75.8 ± 5.6 | 0.055 |
| FCR, g/g | 1.331 ± 0.031^{b} | 1.491 ± 0.112^{a} | 1.321 ± 0.085^{b} | 0.002 |

^{a,b}Values with different superscripts within a row are significantly different (P < 0.05).

Ieal microbial populations. Compared with control (challenge) group, Prototype significantly decreased the count of E. coli in ileum (Table 6).

TABLE 6
Effects of Prototype supplementation on ileal
microbial populations of broilers on day 21.

| | Experimental diets | | | |
|---|---|---|---|---|
| | | Control | Prototype | |
| Item | Control | (Challenge) | (Challenge) | P-value |
| E. coli (lg copies/g) | 4.71 ± 0.48^{b} | 6.77 ± 0.47^{a} | 5.15 ± 0.17^{b} | <0.0001 |
| Salmonella (lg | 3.87 ± 0.51 | 3.65 ± 0.18 | 3.85 ± 0.24 | 0.6338 |
| copies/g) | | | | |
| Bifidobacterium (lg | 4.06 ± 0.56 | 3.24 ± 0.31 | 4.22 ± 0.20 | 0.6405 |
| copies/g) | | | | |
| Lactobacilli (lg | 2.65 ± 0.22 | 2.49 ± 0.13 | 2.61 ± 0.23 | 0.8181 |
| copies/g) | | | | |

^{a,b}Values with different superscripts within a row are significantly different (P < 0.05).

Intestinal junction protein expression. On day 21, compared with control (challenge) group, Prototype significantly increased the gene expression of tight junction proteins in jejunum (Table 7).

TABLE 7
Effects of Prototype supplementation on intestinal
junction protein expression of broilers on day 21.

| | Experimental diets | | | |
|---|---|---|---|---|
| | | Control | Prototype | |
| Item | Control | (Challenge) | (Challenge) | P-value |
| ZO-1 | 1.02 ± 0.24^{b} | 0.72 ± 0.14^{c} | 1.37 ± 0.31^{a} | <0.0001 |
| Occludin | 1.05 ± 0.36^{ab} | 0.90 ± 0.17^{b} | 1.33 ± 0.29^{a} | 0.0378 |
| Claudin | 1.09 ± 0.46^{ab} | 0.73 ± 0.25^{b} | 1.39 ± 0.42 | <0.0001 |

^{a,b,c}Values with different superscripts within a row are significantly different (P < 0.05).

### Example 7

Animals, diets and management. The trial was performed according to the animal welfare regulations of China. The trial was conducted at Sichuan Agricultural University, Ya'an, China. A total of 128 weaned piglets (Duroc×Landrace×Yorkshire) with an average body weight of 5.66±0.2 kg were randomly distributed into four treatments (8 replicates per treatment and 4 weaned piglets per replicate) for the 28-day trial, receiving the control diet (CON), control diet supplemented with Prototype at 100 mg per kg diet (Prototype 100), control diet supplemented with Prototype at 200 mg per kg diet (Prototype 200), and control diet supplemented with Prototype at 300 mg per kg diet (Prototype 300), respectively. The diets were formulated in mash form to meet or exceed the nutrient requirements of weaned piglets as recommended by the National Research Council (2012). All piglets were supplied with mash feed and water ad libitum. On day 8, eight piglets from each group of CON and Prototype 300 were challenged with solution containing 109 CFU E. coli K88 to induce diarrhea.

Growth performance. During the experimental period of 28-day, diet disappearance was recorded, and body weight of piglets were measured on day 1, day 14 and day 28 and average daily gain (ADG), average daily feed intake (ADFI) and feed conversion ratio (FCR) were calculated accordingly. The Prototype improved the growth performance of piglets and decreased the diarrhea index of piglets (Table 8).

TABLE 8
Effect of CIN product supplementation on growth
performance of weaned piglets (1-28 days).

| | Experimental diets | | | | |
|---|---|---|---|---|---|
| | | Prototype | Prototype | Prototype | |
| Item | CON | 100 | 200 | 300 | P-value |
| Initial BW, kg | 5.64 ± 0.21 | 5.66 ± 0.22 | 5.66 ± 0.21 | 5.66 ± 0.21 | 0.785 |
| Final BW, kg | 11.53 ± 0.70 | 10.50 ± 0.49 | 11.14 ± 0.70 | 11.71 ± 0.40 | 0.064 |
| ADG, g/d | 211 ± 15 | 179 ± 12 | 206 ± 16 | 224 ± 11 | 0.055 |
| ADFI, g/d | 450 ± 231 | 409 ± 24 | 436 ± 29 | 460 ± 19 | 0.408 |
| FCR, g/g | 2.14 ± 0.09 | 2.30 ± 0.08 | 2.12 ± 0.04 | 2.07 ± 0.06 | 0.050 |
| Diarrhea index | 1.33 ± 0.15^{a} | 0.68 ± 0.10^{b} | 0.67 ± 0.05^{b} | 0.92 ± 0.12^{b} | <0.01 |

^{a,b}Values with different superscripts within a row are significantly different (P < 0.05).

Intestinal microbial populations. Prototype significantly increased the number of Firmicutes in colon chyme (Table 9). Compared with CON+Challenge group, Prototype+Challenge group significantly increased the count of Lactobacillus.

TABLE 9
Effect of Prototype supplementation on intestinal microbial populations of weaned piglets on day 10.

| | Experimental diets | | | | | | |
|---|---|---|---|---|---|---|---|
| | | | | Prototype | P-value | | |
| | | CON + | Prototype | 300 + | | | Prototype × |
| Item | CON | Challenge | 300 | Challenge | Prototype | Challenge | Challenge |
| Total | 1.00 ± 0.06 | 1.00 ± 0.04 | 1.02 ± 0.04 | 0.88 ± 0.07 | 0.836 | 0.068 | 0.539 |
| bacteria | | | | | | | |
| Firmicutes | 1.00 ± 0.06^{a} | 0.57 ± 0.07^{b} | 0.97 ± 0.10^{a} | 1.09 ± 0.10^{a} | 0.005 | 0.065 | 0.002 |
| Escherichia | 1.00 ± 0.62 | 1.09 ± 0.31 | 1.05 ± 0.22 | 1.04 ± 0.26 | 0.419 | 0.597 | 0.507 |
| coli | | | | | | | |
| Lactobacillus | 1.00 ± 0.22^{a} | 0.41 ± 0.08^{b} | 0.88 ± 0.18^{ab} | 1.13 ± 0.18^{a} | 0.097 | 0.330 | 0.024 |

^{a, b}Values with different superscripts within a row are significantly different (P < 0.05).

Intestinal junction protein expression. On day 10, compared with control (challenge) group, Prototype improved the intestinal barrier function of piglets (Table 10).

TABLE 10
Effects of Prototype supplementation on intestinal junction
protein expression of weaned piglets on day 10.

| | Experimental diets | | | | | | |
|---|---|---|---|---|---|---|---|
| | | | | Prototype | P-value | | |
| | | CON + | Prototype | 300 + | | | Prototype × |
| Item | CON | Challenge | 300 | Challenge | Prototype | Challenge | Challenge |
| ZO-1 | 1.00 ± 0.09 | 0.96 ± 0.09 | 1.10 ± 0.18 | 1.27 ± 0.09 | 0.083 | 0.599 | 0.369 |
| Occludin | 1.00 ± 0.12^{b} | 1.15 ± 0.16^{b} | 1.67 ± 0.29^{a} | 1.31 ± 0.13^{ab} | 0.021 | 0.526 | 0.133 |
| Claudin | 1.00 ± 0.17^{b} | 1.09 ± 0.14^{b} | 0.84 ± 0.10^{b} | 1.88 ± 0.36^{a} | 0.129 | 0.009 | 0.026 |

^{a, b}Values with different superscripts within a row are significantly different (P < 0.05).

### Example 8

Animals, diets and management. The trial was performed according to the animal welfare regulations of China. The trial was conducted at Institute of Subtropical Agriculture, Chinese Academy of Sciences, Changsha, China. A total of 80 weaned piglets (Duroc×Landrace×Yorkshire) were randomly distributed into five treatments (8 replicates per treatment and 2 weaned piglets per replicate) for the 28-day trial, receiving the control diet (CON), control diet supplemented with Prototype at 50 mg per kg diet (Prototype 50), control diet supplemented with Prototype at 100 mg per kg diet (Prototype 100), control diet supplemented with Prototype at 200 mg per kg diet (Prototype 200), and control diet supplemented with Prototype at 400 mg per kg diet (Prototype 400), respectively. The diets were formulated in mash form to meet or exceed the nutrient requirements of weaned piglets as recommended by the National Research Council (2012). All piglets were supplied with mash feed and water ad libitum. On day 28, eight piglets from each group of CON and Prototype 400 were selected and intestinal samples were collected.

Growth performance. During the experimental period of 28-days, diet disappearance was recorded, and body weight of piglets were measured on day 1, day 14 and day 28 and average daily gain (ADG), average daily feed intake (ADFI) and feed conversion ratio (FCR) were calculated accordingly. The Prototype significantly increased the ADFI and ADG of piglets (Table 11). Prototype had the trend to improve the BW of piglets on day 28.

TABLE 11
Effects of Prototype supplementation on growth performance of piglets.

| | Experimental diets | | | | | | |
|---|---|---|---|---|---|---|---|
| Item | Control | Prototype 50 | Prototype 100 | Prototype 200 | Prototype 400 | SEM | P-value |
| 1 to 14 d | | | | | | | |
| BW at 14 | 9.78 | 9.87 | 10.06 | 9.91 | 10.43 | 0.66 | 0.909 |
| d | | | | | | | |
| ADG, g/d | 198.08 | 169.23 | 181.41 | 178.85 | 204.81 | 21.21 | 0.555 |
| ADFI, g/d | 402.12^{c} | 461.33^{ab} | 468.58^{b} | 468.43^{b} | 526.12^{a} | 19.30 | 0.000 |
| FCR, g/g | 2.09 | 2.39 | 2.61 | 2.7 | 2.63 | 0.18 | 0.109 |
| 15 to 28 d | | | | | | | |
| BW at 28 | 15.30 | 16.36 | 16.58 | 16.30 | 17.82 | 1.06 | 0.093 |
| d | | | | | | | |
| ADG, g/d | 440.63^{b} | 463.69^{b} | 416.07^{b} | 456.89^{b} | 559.29^{a} | 31.47 | 0.028 |
| ADFI, g/d | 892.56^{b} | 937.97^{b} | 843.62^{b} | 974.18^{ab} | 1092.76^{a} | 53.68 | 0.022 |
| FCR, g/g | 2.13 | 2.02 | 1.91 | 2.14 | 2.10 | 0.07 | 0.129 |
| 1 to 28 d | | | | | | | |
| ADG, g/d | 293.83 | 321.91 | 328.71 | 323.02 | 372.07 | 27.42 | 0.132 |
| ADFI, g/d | 656.42^{b} | 718.96^{b} | 663.61^{b} | 730.67^{b} | 819.94^{a} | 34.83 | 0.005 |
| FCR, g/g | 2.25 | 2.25 | 2.16 | 2.27 | 2.24 | 0.10 | 0.953 |

^{a, b, c}Values with different superscripts within a row are significantly different (P < 0.05).

Intestinal morphology. On day 28, Prototype significantly increased villus height and the ratio of villus height to crypt depth and decreased the crypt depth in ileum of piglets (FIG. 9).

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

It should be further appreciated that minor dosage and formulation modifications of the composition and the ranges expressed herein may be made and still come within the scope and spirit of the present invention.

The foregoing description has been presented for the purposes of illustration and description. It is not intended to be an exhaustive list or limit the invention to the precise forms disclosed. It is contemplated that other alternative processes and methods obvious to those skilled in the art are considered included in the invention. The description is merely examples of embodiments. It is understood that any other modifications, substitutions, and/or additions may be made, which are within the intended spirit and scope of the disclosure. From the foregoing, it can be seen that the exemplary aspects of the disclosure accomplish at least all of the intended objectives.

1. An animal feed ingredient comprising coated cinnamic aldehyde, wherein the coated cinnamic aldehyde includes a cinnamic aldehyde core and an acidic layer.

2. The composition of claim 1, where the acidic layer includes an organic acid selected from the group consisting of citric acid, tartaric acid, malic acid, fumaric acid, sorbic acid, ascorbic acid, lactic acid, oxalic acid, and mixtures thereof.

3. The composition of claim 1, wherein the acidic layer contains citric acid.

4. The composition of claim 1, further comprising a polymer layer.

5. The composition of claim 1, wherein the polymer layer contains sodium carboxymethyl cellulose.

6. The composition of claim 1, wherein the coated cinnamic aldehyde ingredient is stable for up to ninety days after combination with animal feed or raw feed ingredients.

7. A process for preparing a stable cinnamic aldehyde feed ingredient comprising preparing a cinnamic aldehyde core that contains at least 35% by weight cinnamic aldehyde and coating the cinnamic aldehyde core with an organic acid to create an acidic layer.

8. The process of claim 7, where the acidic layer includes an organic acid selected from the group consisting of citric acid, tartaric acid, malic acid, fumaric acid, sorbic acid, ascorbic acid, lactic acid, oxalic acid, and mixtures thereof.

9. The process of claim 7, wherein the acidic layer contains citric acid.

10. The process of claim 7, further comprising coating the cinnamic aldehyde core with a polymer to create a polymer layer.

11. The process of claim 10, wherein the polymer layer contains sodium carboxymethyl cellulose.

12. The process of claim 7, where the coating step is performed using a fluid bed.

13. The process of claim 7, where the coating step is performed using pan coating or extrusion spheronization.

14. The process of claim 7, wherein the coated cinnamic aldehyde ingredient is stable for up to ninety days after combination with animal feed or raw feed ingredients.

15. A method of improving the growth of an animal by administering a coated cinnamic aldehyde ingredient to the animal, wherein the coated cinnamic aldehyde includes a cinnamic aldehyde core that contains at least 35% by weight cinnamic aldehyde, and an acidic coating.

16. The method of claim 15, wherein the acidic coating comprises an organic acid.

17. The method of claim 15, wherein the acidic coating comprises an acid selected from the group consisting of citric acid, tartaric acid, malic acid, fumaric acid, sorbic acid, ascorbic acid, lactic acid, oxalic acid, and mixtures thereof.

18. The method of claim 15, wherein the cinnamic aldehyde includes a polymer coating.

19. The method of claim 18, wherein the polymer coating comprises sodium carboxymethyl cellulose.

20. The method of claim 15, wherein the coated cinnamic aldehyde ingredient is stable for up to ninety days after combination with animal feed or raw feed ingredients.
